(19) United States
(12) Patent Application Publication
(10) Pub. No.: US 2015/0279544 A1
(43) Pub. Date: Oct. 1, 2015

(54) Transformer Having An Interlocking Core Frame

(71) Applicants: Bandeep SINGH, (US); Chester M. NEAL, (US)

(72) Inventors: Bandeep Singh, Knightdale, NC (US); Chester M. Neal, Narrows, VA (US)

(73) Assignee: ABB Technology AG, Zurich (CH)

(21) Appl. No.: 14/435,249

(22) PCT Filed: Oct. 13, 2013
(86) PCT No.: PCT/US13/64749

§ 371 Date: Apr. 13, 2015

Related U.S. Application Data
(60) Provisional application No. 61/716,977, filed on Oct. 22, 2012.

(51) Int. Cl. H01F 27/26; H01F 41/04; H01F 1/16; H01F 41/02; H01F 27/28; H01F 27/245

(52) U.S. Cl. CPC H01F 27/263; H01F 27/28; H01F 27/245; H01F 1/16; H01F 41/0233; H01F 41/04

(57) ABSTRACT

A distribution transformer having an interlocking core frame is provided. The core frame encloses a transformer core having at least one phase and provides compression on the core of the transformer to bind the assembly together. First and second clamps of the core frame contain receiving cut-out portions for the tabbed leg plates. The core clamp cut-out portions and leg plate tabs form an interlocking connection. A first section of the first and second clamps, contacting the leg plates at an angle perpendicular to the leg plates provides support to retain the interlocked position between the first and second clamps and corresponding leg plates. Lifting eyebolts are provided in the first core clamps for moving and mounting the transformer at the desired location.

### FIELD OF INVENTION

The present application is directed to distribution transformers and, more particularly, to supports for cores of distribution transformers.

### BACKGROUND

A frame for a core of a distribution transformer provides mechanical stability to the transformer by compressing the yokes of the core and holding the overall assembly together. The construction of a conventional transformer core frame typically involves welding to connect component members of the core frame. The production and assembly of such core frames is time-consuming. Additionally, welded core frame members tend to corrode and become unstable over time.

### SUMMARY

An object of the present invention is to provide a transformer core frame having interlocking members. The core frame encloses a ferromagnetic core having at least one core limb extending between upper and lower yokes. The core frame is formed of first and second core clamps and leg plates. The first and second core clamps compress the upper and lower yokes, respectively and the leg plates are placed on opposing sides of the at least one limb. The first and second core clamps have cut-out portions formed therein to receive tabs of opposing ends of the leg plates to form an interlock between the first and second core clamps and leg plates.

Another object of the present invention is to provide method for forming a distribution transformer. The method includes:
a. providing a ferromagnetic core comprising at least one limb extending between first and second yokes;
b. forming a frame for holding the core, comprising:
   providing leg plates, each of which has opposing first and second end portions, the first and second end portions having tab formed therein, respectively;
   providing first and second core clamps each of which has cut-out portions formed therein;
   placing one of the leg plates on one side of the at least one limb;
   placing the other one of the leg plates on the opposing side of the at least one limb;
   placing the tabs of the leg plates into the cut-out portions of the first and second clamps; and
c. mounting at least one coil assembly to the at least one limb.

### BRIEF DESCRIPTION OF THE DRAWINGS

In the accompanying drawings, structural embodiments are illustrated that, together with the detailed description provided below, describe exemplary embodiments of a transformer having an interlocking core frame. One of ordinary skill in the art will appreciate that a component may be designed as multiple components or that multiple components may be designed as a single component.

Further, in the accompanying drawings and description that follow, like parts are indicated throughout the drawings and written description with the same reference numerals, respectively. The figures may not be drawn to scale and the proportions of certain parts may have been exaggerated for convenience of illustration.

FIG. 1 is a front perspective view of a distribution transformer having a core frame with interlocking members;

FIG. 2 shows a front view of the distribution transformer having the core shown in phantom;

FIG. 3 is a front view of one of the leg plates of the core frame;

FIG. 4A is a top view of a front-facing first clamp of the first core clamps, depicted as a flat piece of sheet metal prior to the front-facing first clamp being bent along the broken lines;

FIG. 4B is a top view of a rear-facing first clamp of the first core clamps, depicted as a flat piece of sheet metal prior to the rear-facing first clamp being bent along the broken lines;

FIG. 4C is a top view of the distribution transformer of FIG. 1; and

FIG. 5 is a side view of the distribution transformer of FIG. 1.

### DETAILED DESCRIPTION

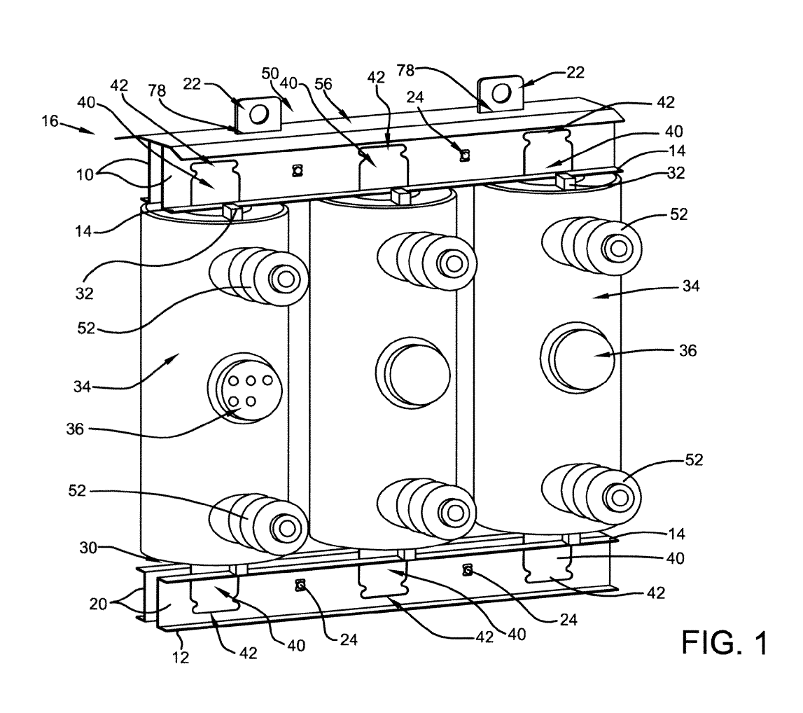

A dry-type distribution transformer 50 having an interlocking core frame 16 embodied in accordance with the present invention is shown in FIG. 1. The core frame 16 is comprised of first and second core clamps 10, 20 and leg plates 40. The distribution transformer 50 is a single-phase or three-phase transformer. It should be understood that a liquid-filled distribution transformer containing dielectric fluid may utilize the core frame 16 of the present invention.

Referring now to FIG. 2, the distribution transformer 50 is shown with a core 30 in phantom. The core 30 is comprised of thin, stacked laminations of magnetically permeable material, such as grain-oriented silicon steel or amorphous metal. The laminations are typically arranged in stacks so that the core 30 has at least one limb 62, 64 disposed vertically between a pair of yokes 61, 65 disposed horizontally. Alternatively, the core 30 may be formed of a wound construction.

The at least one limb 62, 64 is comprised of an inner limb 64 and two outer limbs 62 in a three-phase distribution transformer 50. Further, the core limbs 62, 64 and yokes 61, 65 typically connect to form a pair of core windows 67. A coil assembly 34 is disposed around the at least one limb 62, 64 and comprises high-voltage and low-voltage coil windings. The high-voltage and low-voltage coil windings are often arranged concentrically along the length of the at least one limb 62, 64. In one embodiment, the high-voltage winding is arranged around and encompasses the low-voltage winding. The coil assemblies 34 may be encased in a polymeric material or an epoxy material to form an outer surface from which high-voltage bushings 52 and tap projections 36 containing at least one tap extend.

The transformer core 30 is enclosed within the core frame 16. The core frame 16 retains the coil assemblies 34 in about an equally spaced-apart manner on the core 30. The coil assemblies 34 fill the core window 67 as completely as possible without allowing the contact of adjacent coil assemblies 34.

The core frame 16 is formed from a pair of first core clamps 10, a pair of second core clamps 20 and leg plates 40. The first core clamps 10 are placed on opposing sides of the upper yoke 61. The second core clamps 20 are placed on opposing sides of the lower yoke 65. The first and second core clamps 10, 20 compress the upper and lower yokes 61, 65, respectively.

The leg plates 40 are placed on both sides of the at least one core limb 62, 64. In a three-phase distribution transformer 50 core frame 16, the at least one core limb 62, 64 is comprised of outer and inner core limbs 62, 64 and six leg plates 40 are utilized. In that same embodiment three cut-outs portions 60 are formed in each of the first core clamps 10 and each of the second core clamps 20, respectively. Further, each of three leg plates 40 are in contact with the front side of the corresponding at least one core limb 62, 64 and each of three leg plates 40 are in contact with the rear side or opposing side of the corresponding at least one core limb 62, 64.

In a single-phase embodiment, the core 30 has two core limbs 62 and four leg plates 40. In that same embodiment, each of the first and second core clamps 10, 20 have two cut-out portions 60 formed therein.

The first and second core clamps 10, 20 and the leg plates 40 may be constructed from a different material than the core 30. For example, the first and second clamps 10, 20 and the leg plates 40 may be comprised of regular, non-electrical grade carbon steel, which has different magnetic properties than grain-oriented silicon steel or amorphous metal.

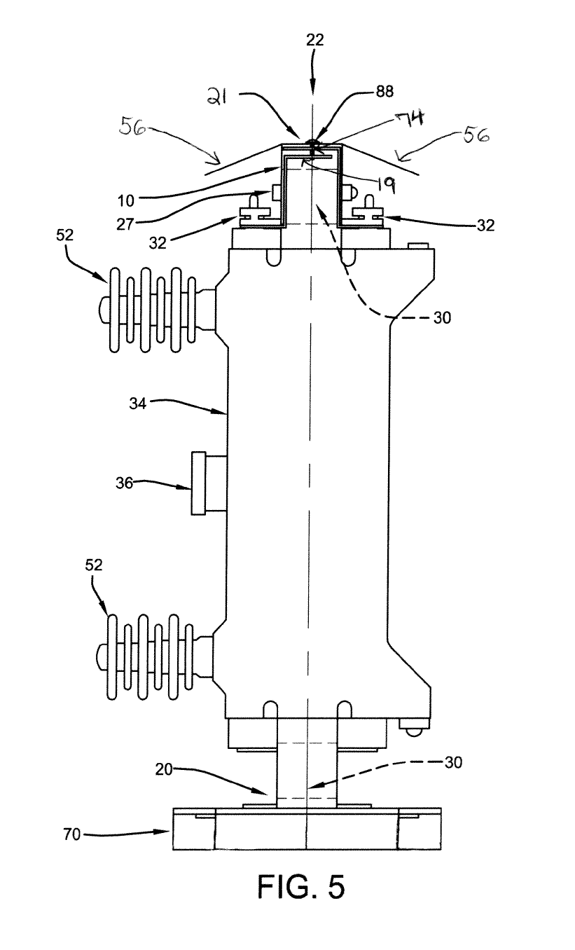

The first and second core clamps 10, 20, leg plates 40, cut-out portions 60, first slots 38, and other openings 24, 25, 74, 76 are laser-cut to produce precision parts. Each of the first core clamps 10 is bent to produce a U-shape when the first core clamps 10 are connected together as shown in FIG. 5. Each of the second core clamps 20 is bent to form a C-shape as is shown in FIG. 1 and as will be described in more detail below.

The first and second core clamps 10, 20 each have first sections 12, 14 that extend outwardly from a second section 18 of the first and second core clamps 10, 20. The first and second core clamps 10, 20 have cut-out portions 60 formed therein for receiving tabs 42 formed in first and second ends of leg plates 40. The precision cut of the tabs 42 and cut-out portions 60 along with the first section 14 holds the leg plates 40 and first and second clamps 10, 20 securely in the interlocking position depicted in FIG. 1. The support flanges 14 are located perpendicular to and contact the leg plates 40 at support edge 17 when the leg plates 40 and core clamps 10, 20 are in an interlocking position.

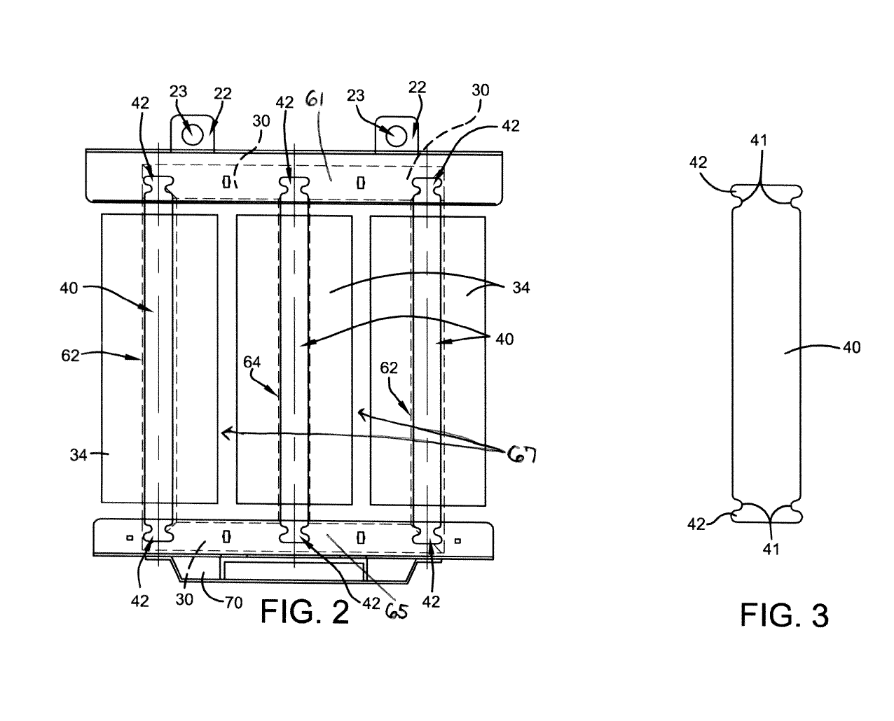

Each leg plate 40 has a tab 42 and a notch 41 formed in opposing ends as depicted in FIG. 3. In the three-phase distribution transformer 50 embodiment, there are six leg plates 40 wherein each leg plate 40 is in contact with the at least one limb 62, 64 on both sides of the at least one limb 62, 64. More particularly, three leg plates 40 are in contact with the front side of the corresponding at least one core limb 62, 64 and three leg plates 40 are in contact with the rear side of the corresponding at least one core limb 62, 64.

The leg plates 40 bear the load of the assembled transformer 50 and core frame 16 when in an interlocking position with the cut-out portions 60 of the first and second core clamps 10, 20, respectively. The support edges 17 formed by the bending of the first and second core clamps 10, 20 along broken lines 80, 82, 84 further reinforce and retain the tabs 42 of the leg plates 40 in place in the cut-out portions 60 of the first and second clamps 10, 20.

Referring now to FIG. 2, the distribution transformer 50 is shown with the core 30 in phantom to depict the arrangement of the leg plates 40 and first and second core clamps 10, 20 in relation to the core 30. The leg plates 40 are positioned in contact with the core 30 so that each leg plate 40 aligns with the corresponding at least one core limb 62, 64 of the core 30. In one embodiment, there is a thin layer of insulation such as a glass-fiber reinforced polyester sheet placed between the leg plates 40 and the core 30.

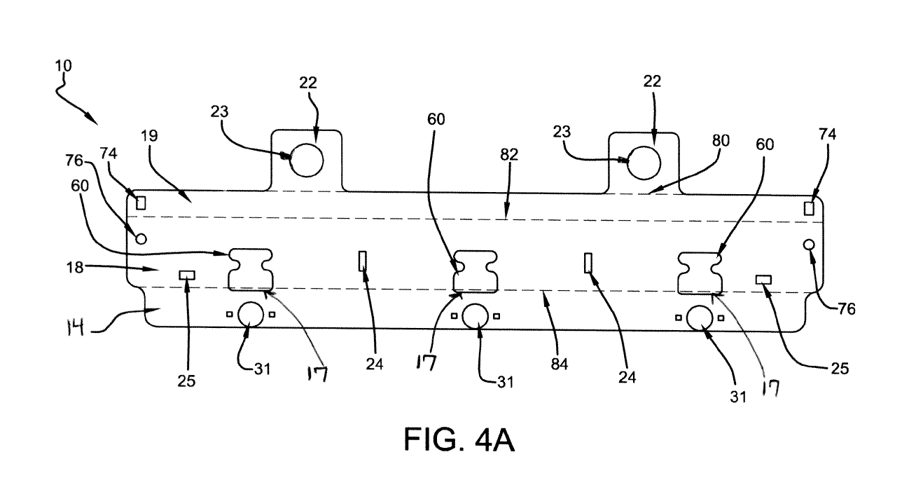

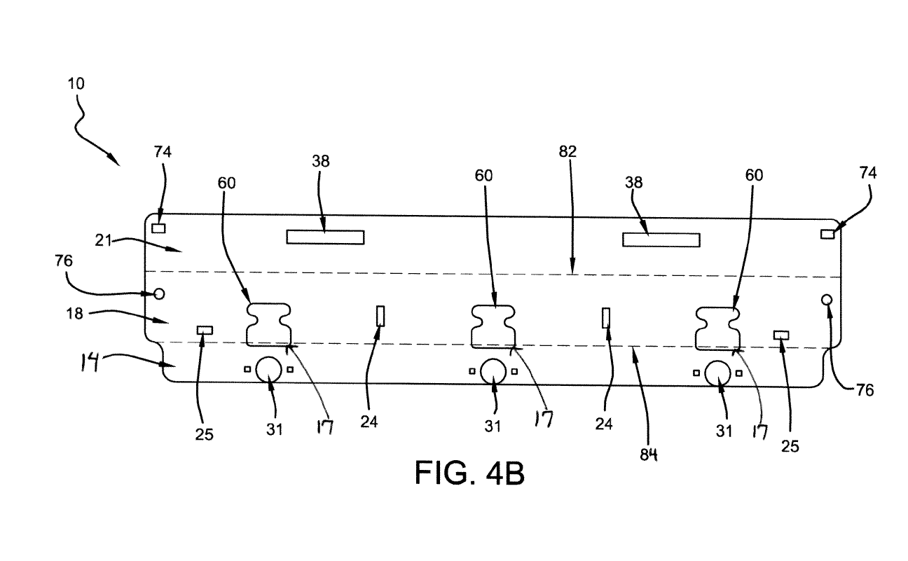

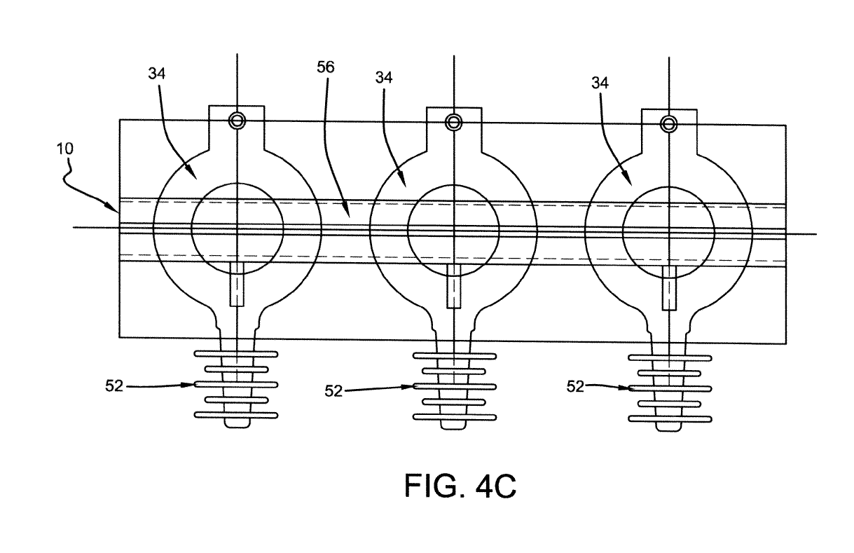

With reference now to FIGS. 4A and 4B, the first and second core clamps 10, 20 are depicted as flat pieces in order to show greater detail. The first and second core clamp 10, 20 sections 14, 18, 19, 21 are bent along broken lines 80, 82, 84 at 90 degree angles upward or downward from adjacent sections 14, 18, 19, 21. The front-facing clamp of the pair of first core clamps 10 is depicted in FIG. 4A and the rear-facing clamp of the pair of first core clamps 10 is depicted in FIG. 4B.

The front-facing first core clamp 10 of FIG. 4A has four sections 14, 18, 19, 23. The first section 14 has openings 31 for coil support blocks 32 and supports the interlock between the leg plates 40 and the cut-out portions 60. The tabs 42 are firmly held in the cut-out portions 60 of the second section 18 by the support edges 17 of the first section 14. The second section 18 has cut-out portions 60, core bolt openings 24, compression bolt openings 25, and ground connection openings 76. The third section 19 has openings 74 for bolts that connect the front- and rear-facing first core clamps 10 together. The fourth section 23 has eyebolts 22 for lifting and mounting the distribution transformer 50 onto a utility pole or another location. The first clamp 10 is bent at along dotted lines 82 and 84 so that the second section 18 is 90 degrees upward from the plane in which first section 14 is located and the third section 19 is bent 90 degrees downward in relation to the plane of the second section 18. The fourth section 23 is bent along line 80 at angle of 90 degrees upward from the plane of the third section 19.

Referring now to FIG. 4B, the rear-facing clamp of the pair of first core clamps 10 is depicted. The rear-facing first clamp 10 has three sections 14, 18, 21. The rear-facing first clamp 10 is bent along dotted lines 82 and 84 so that the second portion 18 is at a 90 degree angle upward in relation to the plane of the first section 14 and the third section 21 is bent at a 90 degree angle downward in relation to the plane of the second portion 18. The third portion 21 has first slots 38 to receive the eyebolts 22 of the front-facing first clamp 10.

The eyebolts 22 extend upward through the first slots 38 when the front- and rear-facing first clamps 10 are connected together. The front- and rear-facing first clamps 10 are held together by bolts in openings 24, 25, 74. The bolts in openings 24, 25 hold the front- and rear-facing first clamps 10 together in a position parallel to one another.

The bolts in openings 74 connect the sections 19, 21 together and further connect sections 19, 21 to a roof plate 56. The roof plate 56 is formed of sheet metal that is bent to form a flat center portion having two edge portions that extend obliquely from the flat center portion. The roof plate 56 has second slots 78 similar to first slots 38 to receive the eyebolts 22 of the first core clamps 10. The roof plate 56 in conjunction with first clamps 10 and eyebolts 22 stabilize the core frame 16 when the core frame 16 is lifted, transported and mounted.

The pair of second core clamps 20 each have a C-shape. The second core clamps 20 are connected together using bolts placed through openings 24, 25 and secured by nuts. The second core clamps 20 further connect to a foot 70 as depicted in FIGS. 2 and 5 using carriage head bolts which are 0.75 inches in diameter and 2.25 inches in length. In one embodiment, eight carriage head bolts are used, to connect the second core clamps 20 to the foot 70.

The second core clamps 20 each have cut-out portions 60 formed therein. In the three-phase transformer 50 embodiment, each of the second core clamps 20 has three cut-out portions 60 formed therein, each of the three cut-out portions 60 for receiving a corresponding one of the leg plate tabs 42. The second core clamps 20 each have first sections 14 for retaining the leg plates 40 in an interlocking position with the cut-out portions 60.

Referring now to FIG. 4, a top view of the distribution transformer 50 is depicted. The coil assemblies 34 are shown mounted to the core 30 with the first core clamps 10 holding the coil assemblies 34 in place on the core 30. The high-voltage bushings 52 are shown as extending from the surface of the coil assemblies 34.

Referring now to FIG. 5, a side view of the distribution transformer 50 shows the connection between the front- and rear-facing first core clamps 10 in more detail. The third section 21 of the rear-facing first core clamp 10 is located over and contacts the third section 19 of the front-facing first core clamp 10. The front- and rear-facing first core clamps 10, 20 are held together by bolts 88 placed into openings 74. The eyebolts 22 placed through the corresponding first slots 38 and second slots 78 add further stability to the assembly of the core frame 16.

A method for forming a distribution transformer 50 with an interlocking core frame 16 includes the steps of providing a ferromagnetic core comprising at least one limb 62, 64 extending between the upper and lower yokes 61, 65. First and second core clamps 10, 20 and leg plates 40 are provided for forming a core frame 16 for holding the core 30. The core frame 16 is formed by placing leg plates 40 on each side of the at least one core limb 62, 64 and second core clamps 20 on each side of the lower yoke 65. Then, the tabs 42 of the leg plates 40 are placed into receiving cut-out portions 60 of the second core clamps 10, 20, respectively so that the second core clamps 20 and leg plates 40 are in an interlocking position.

Coil assemblies 34 are mounted to or placed over the leg plates 40 and core limbs 62, 64 so that the leg plates 40 and core limbs 62, 64 extend through the coil assemblies. The upper yoke 61 is secured to the core limbs 62, 64. The first core clamps are placed on each side of the upper yoke 61. Tabs 42 of the leg plates 60 are then placed into the first clamp 10 cut-out portions 60, respectively, so that the first core clamps 10 and leg plates 40 are in an interlocking position.

While the present application illustrates various embodiments of a transformer 50 having an interlocking core frame 16, and while these embodiments have been described in some detail, it is not the intention of the applicant to restrict or in any way limit the scope of the appended claims to such detail. Additional advantages and modifications will readily appear to those skilled in the art. Therefore, the invention, in its broader aspects, is not limited to the specific details, the representative embodiments, and illustrative examples shown and described. Accordingly, departures may be made from such details without departing from the spirit or scope of the applicant's general inventive concept.

What is claimed is:

1. A distribution transformer comprising:
a ferromagnetic core comprising at least one limb extending between the first and second yokes;
at least one coil assembly mounted to at least one limb;
a frame for holding the core, the frame comprising:
first core clamps having cut-out portions formed therein;
second core clamps having cut-out portions formed therein;
first and second leg plates, said leg plates each having first and second ends, said first and second ends each having tabs formed therein; and
wherein the first and second tabs are received in the cut-out portions of the first and second clamps, respectively.

2. The distribution transformer of claim 1, wherein when each of the tabs fit into the cut-out portions to form an interlock between the first and second leg plates and first and second clamps, respectively.

3. The distribution transformer of claim 2, wherein three cut-out portions are formed in each of the first and second clamps, respectively, in a three-phase embodiment.

4. The distribution transformer of claim 2, wherein two cut-out portions are formed in each of the first and second clamps, respectively, in a single-phase embodiment.

5. The distribution transformer of claim 2 wherein first sections of the first core clamps and second core clamps contact corresponding ones of said leg plates at an angle perpendicular to said leg plates, said first sections operable to maintain each of said leg plate tabs in an interlocking position with the corresponding ones of the cut-out portions.

6. The distribution transformer of claim 1 wherein first slots are formed in a third section of said first core clamps and wherein eyebolts are received in said first slots and extend upward from a top surface of said first core clamps.

7. The distribution transformer of claim 6 wherein a roof plate contacts said top surface of said first core clamps, said roof plate having a second slot formed therein, and said eyebolts extending upward through said second slot.

8. The distribution transformer of claim 1, wherein each of the leg plates are in contact with at least one limb of the core.

9. The distribution transformer of claim 1, wherein at least one limb further comprises a third limb, disposed between the first and second limbs.

10. The distribution transformer of claim 9, wherein at least one coil assembly comprises first, second and third coil assemblies mounted to the first, second and third limbs, respectively.

11. The distribution transformer of claim 10, wherein a corresponding one of said leg plates extends through the first, second and third core assemblies, respectively.

12. The distribution transformer of claim 11, wherein each of the first, second and third coil assemblies comprises a high-voltage winding disposed around a low-voltage winding.

13. The distribution transformer of claim 10, wherein the first and second yokes and the first, second and third limbs are each comprised of a stack of laminations.

14. The distribution transformer of claim 13, wherein the first and second core clamps and leg plates of the core frame are each composed of a material having different magnetic properties than the laminations of the core.

15. The distribution transformer of claim 14, wherein the laminations of the core are composed of grain-oriented silicon steel, and wherein the leg plates and first and second core clamps of the core frame are composed of regular carbon steel.

16. A method of forming a distribution transformer, comprising:
a. Providing a ferromagnetic core comprising at least one limb extending between the first and second yokes;
b. Forming a frame for holding the core, comprising:
providing leg plates, each of which has opposing end portions and tabs formed in said opposing end portions;
providing first and second core clamps each of which has cut-out portions formed therein;
placing one of the leg plates on one side of the at least one limb;
placing the other one of the leg plates on the other side of the at least one limb;
placing the first tab of the leg plate into a cut-out portion in the first core clamps;
placing the second tab of the leg plate into the cut-out portion in the second core clamps; and
c. Mounting at least one coil assembly to at least one limb.

17. The method of claim 16, wherein the at least one limb comprises first, second and third limbs, and the at least one coil assembly comprises first, second and third coil assemblies, and wherein the step of mounting the at least one coil assembly comprises mounting the first, second and third coil assemblies to the first, second and third limbs, respectively.

18. The method of claim 17, wherein the mounting of the first coil assembly comprises placing the first coil assembly over the first limb and leg plate; and wherein the mounting of the second coil assembly comprises placing the second coil assembly over the second limb and leg plate.
